(19) United States
(12) Patent Application Publication
(10) Pub. No.: US 2025/0272874 A1
(43) Pub. Date: Aug. 28, 2025

(54) PHOTOGRAPHING POSITION AND POSTURE ESTIMATION APPARATUS, SYSTEM, AND PHOTOGRAPHING POSITION AND POSTURE ESTIMATION METHOD

(71) Applicant: NEC Corporation, Tokyo (JP)

(72) Inventors: Jiro ABE, Tokyo (JP); Kazumine OGURA, Tokyo (JP); Gaku NAKANO, Tokyo (JP)

(73) Assignee: NEC Corporation, Tokyo (JP)

(21) Appl. No.: 19/040,998

(22) Filed: Jan. 30, 2025

(30) Foreign Application Priority Data
Feb. 26, 2024 (JP) 2024-026437

(51) Int. Cl. G06T 7/73; G06T 15/20

(52) U.S. Cl. CPC G06T 7/74; G06T 15/20; G06T 2207/10028; G06T 2207/30244

(57) ABSTRACT

To maintain the accuracy of the estimation of a photographing position and a photographing posture of a photographed image in the case where 3D data containing no color information is used. A photographing position and posture estimation apparatus according the present disclosure includes: feature value calculation unit configured to calculate shape feature values from specific 3D (three-dimensional) data; generation unit configured to generate virtual image information by associating the shape feature values projected onto an image area when the 3D data is converted into an image based on specific virtual camera information with respective pixel positions in the image area; and similarity calculation unit configured to calculate a degree of similarity between the virtual image information and an input image.

### INCORPORATION BY REFERENCE

This application is based upon and claims the benefit of priority from Japanese patent application No. 2024-026437, filed on Feb. 26, 2024, the disclosure of which is incorporated herein in its entirety by reference.

### TECHNICAL FIELD

The present disclosure relates to a photographing position and posture estimation apparatus, a system, a photographing position and posture estimation method, and a program.

### BACKGROUND ART

Patent Literature 1 discloses a technology related to a matching apparatus for performing matching between 3D (three-dimensional) mesh data to which texture information is provided and a photographed image. The matching apparatus disclosed in Patent Literature 1 converts input 3D mesh data into a 2D (two-dimensional) image that is supposed to be obtained when the subject is photographed from a reference camera posture, and calculates feature values of each of the converted 2D image and an input photographed image (2D image). Then, the matching apparatus calculates the degree of similarity between these images by comparing their calculated feature values. Further, when the degree of similarity is equal to or higher than a threshold, the matching apparatus estimates that the input photographed image was taken from the photographing position and the photographing posture (hereinafter referred to as “photographing position and posture”) in the reference camera posture.
Patent Literature 1: Japanese Unexamined Patent Application Publication No. 2023-153664

### SUMMARY

The technology disclosed in Patent Literature 1 is based on the premise that texture information (color information) is provided for each surface of the 3D mesh data. Further, in the technology disclosed in Patent Literature 1, the 3D mesh data is converted into a 2D image and the feature values of the 2D image are calculated by using the color information thereof, so that the degree of similarity between the converted 2D image and the input photographed image is calculated. Therefore, in the technology disclosed in Patent Literature 1, in the case where 3D data containing no color information is used, the accuracy of the estimation of the photographing position and posture of the input photographed image may deteriorate.

In view of the above-described problem, an example object of the disclosure is to provide a photographing position and posture estimation apparatus, a system, a method, and a program for maintaining the accuracy of the estimation of the photographing position and posture of a photographed image, i.e., the photographing position and posture from which a photographed image has been taken, in the case where 3D data containing no color information is used.

A photographing position and posture estimation apparatus according an example aspect of the present disclosure includes:
feature value calculation means for calculating shape feature values from specific 3D (three-dimensional) data;
generation means for generating virtual image information by associating the shape feature values projected onto an image area when the 3D data is converted into an image based on specific virtual camera information with respective pixel positions in the image area; and similarity calculation means for calculating a degree of similarity between the virtual image information and an input image.

A photographing position and posture estimation system according to an example aspect of the present disclosure includes:
a photographing terminal; and
a photographing position and posture estimation apparatus connected to the photographing terminal so that they can communicate with each other, in which the photographing position and posture estimation apparatus is configured to:
calculate shape feature values from 3D data of a specific object;
generate virtual image information by associating the shape feature values projected onto an image area when the 3D data is converted into an image based on virtual camera information with respective pixel positions in the image area;
calculate, when the photographing terminal receives an image obtained by photographing the object as an input image, a degree of similarity between the virtual image information and the input image;
estimate a photographing position and a photographing posture corresponding to the input image based on the virtual camera information and the degree of similarity; and
return the estimated photographing position and posture to the photographing terminal.

In a photographing position and posture estimation method according to an example aspect the present disclosure, a computer:
calculates shape feature values from specific 3D data;
generates virtual image information by associating the shape feature values projected onto an image area when the 3D data is converted into an image based on specific virtual camera information with respective pixel positions in the image area; and
calculates a degree of similarity between the virtual image information and an input image.

A photographing position and posture estimation program according to an example aspect of the present disclosure causes a computer to perform:
a process for calculating shape feature values from specific 3D data;
a process for generating virtual image information by associating the shape feature values projected onto an image area when the 3D data is converted into an image based on specific virtual camera information with respective pixel positions in the image area; and
a process for calculating a degree of similarity between the virtual image information and an input image.

An example advantage according to the above-described embodiments is to be able to maintain the accuracy of the estimation of a photographing position and a photographing posture of a photographed image in the case where 3D data containing no color information is used.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram showing a configuration of a photographing position and posture estimation apparatus according to the present disclosure;

FIG. 2 is a flowchart showing a flow of a photographing position and posture estimation method according to the present disclosure;

FIG. 3 is a block diagram showing a configuration of a photographing position and posture estimation apparatus according to the present disclosure;

FIG. 4 is a diagram for explaining a concept of a data structure of virtual image information according to the present disclosure;

FIG. 5 is a flowchart showing a flow of a photographing position and posture estimation process according to the present disclosure;

FIG. 6 is a diagram for explaining a concept of a method for visualizing virtual image information according to the present disclosure;

FIG. 7 shows an example of an image showing a corresponding relationship of pixels estimated by local matching according to the present disclosure;

FIG. 8 is a flowchart showing a flow of a process for training an estimation model according to the present disclosure;

FIG. 9 is a flowchart showing a flow of a process for training an estimation model according to the present disclosure;

FIG. 10 is a flowchart showing a flow of a process for training an estimation model according to the present disclosure;

FIG. 11 is a flowchart showing a flow of a photographing position and posture estimation process when a global matching process and a local matching process are used in combination according to the present disclosure;

FIG. 12 is a block diagram showing a hardware configuration of a photographing position and posture estimation apparatus according to the present disclosure;

FIG. 13 is a flowchart showing a flow of a photographing position and posture estimation process performed for two input images according to the present disclosure;

FIG. 14 is a block diagram showing a configuration of a photographing position and posture estimation system according to the present disclosure;

and

FIG. 15 is a sequence chart showing a flow of a photographing position and posture estimation process according to the present disclosure.

### EXAMPLE EMBODIMENT

An example embodiment according to the present disclosure will be described hereinafter in detail with reference to the drawings. The same reference numerals (or symbols) are assigned to the same or corresponding elements throughout the drawings, and redundant descriptions thereof are omitted as appropriate to clarify the descriptions.

### First Example Embodiment

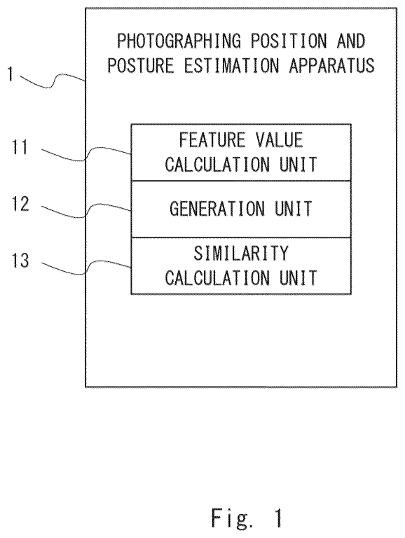

FIG. 1 is a block diagram showing a configuration of a photographing position and posture estimation apparatus 1. The photographing position and posture estimation apparatus 1 is an information processing apparatus for estimating a photographing position and a photographing posture on 3D (three-dimensional) data of a specific target object created in advance from an image of the target object photographed by a camera. Alternatively, the photographing position and posture estimation apparatus 1 may be an information processing apparatus for training a model for estimating a photographing position and a photographing posture. Note that the target object may be, for example, a structure such as a bridge or a plurality of objects disposed in an indoor space. Further, the photographing position and posture estimation apparatus 1 may be used, for example, for inspecting a structure or the like. The photographing position and posture estimation apparatus 1 includes a feature value calculation unit 11, a generation unit 12, and a similarity calculation unit 13. Note that the feature value calculation unit 11, the generation unit 12, and the similarity calculation unit 13 may be used as means for calculating feature values, means for generating virtual image information, and means for calculating a degree of similarity, respectively.

The feature value calculation unit 11 calculates shape feature values from specific 3D data. The “3D data” is data representing the 3D structure of a target object. For example, the 3D data preferably consists of a set of data points (point cloud data) representing the structure (at least the external shape) of the target object in a predetermined 3D space by using coordinates in a 3D coordinate system. Alternatively, the 3D data may be mesh data, CAD (Computer Aided Design) data, BIM (Building Information Modeling)/CIM (Construction Information Modeling) data, implicit function expression data created by NeRF (Neural Radiance Fields) technology, or the like. Note that the 3D data is not limited to these examples as long as it is data representing the 3D structure of a target object. In particular, the 3D data in the present disclosure may be data containing no color information. The “shape feature value” is vector information representing, for the respective data point, a feature of a shape in relation to data points surrounding that data point in a plurality of dimensions.

The generation unit 12 generates virtual image information by associating shape feature values projected onto an image area when the 3D data is converted into an image based on specific virtual camera information with respective pixel positions in the image area. Note that the “virtual camera information” is information about a virtual camera that is, in order to photograph a target object in a 3D space, virtually installed, i.e., imaginably installed, at a predetermined position and in a predetermine posture (at a predetermined photographing angle) in the 3D space. The virtual camera information contains at least 3D coordinates (position) and a posture in the 3D space. Further, the virtual camera information also contains the frame size of an image to be taken, i.e., the number of pixels (the number of pixels in the vertical direction and in the horizontal direction). Further, the virtual camera information may contain an angle of view in the 3D space.

The “virtual image information” is information in which shape feature values are associated with respective pixel positions in an image that is generated when a target object is photographed based on the virtual camera information. That is, when the generation unit 12 convers 3D data into an image based on the specific virtual camera information, i.e., performs 3D rendering, it uses shape feature values at data points corresponding to respective pixels among the data points in the 3D data as information corresponding to pixel values. In other words, when the generation unit 12 convers 3D data into an image based on the virtual camera information, it projects shape feature values at respective data points in the 3D data onto the image area instead of projecting color information onto the image area. Then, the generation unit 12 generates virtual image information by associating the projected shape feature values with the respective pixel positions in the image area. The “image area” is a 2D (two-dimensional) area (planar area) where a target object is converted into an image when the target object is photographed by a virtual camera at a predetermined position and a predetermined posture in the 3D space. Note that the shape feature values may be those that are converted from shape feature values corresponding to a plurality of data points. Further, the shape feature values may be information obtained by performing a predetermined conversion or the like on shape feature values calculated by the feature value calculation unit 11.

The similarity calculation unit 13 calculates a degree of similarity between the virtual image information and an input image. The similarity calculation unit 13 may calculate a degree of similarity between the virtual image information and the input image through (M1) global matching. For example, the similarity calculation unit 13 may calculate a degree of similarity between a set of pixel positions (over the entire frame size) in the virtual image information and those over the entire frame size of the input image. Alternatively, the similarity calculation unit 13 may calculate a degree of similarity between the virtual image information and the input image by obtaining a corresponding relationship between pixels through (M2) local matching. That is, the similarity calculation unit 13 may calculate, as a degree of similarity, a degree to which both specific pixel positions in the virtual image information and those in the input image represent the same positions on the target object (the same data points in the 3D data). Then, the similarity calculation unit 13 may calculate a degree of similarity between the virtual image information and the input image by integrating (or summarizing) degrees of similarity of respective pixels.

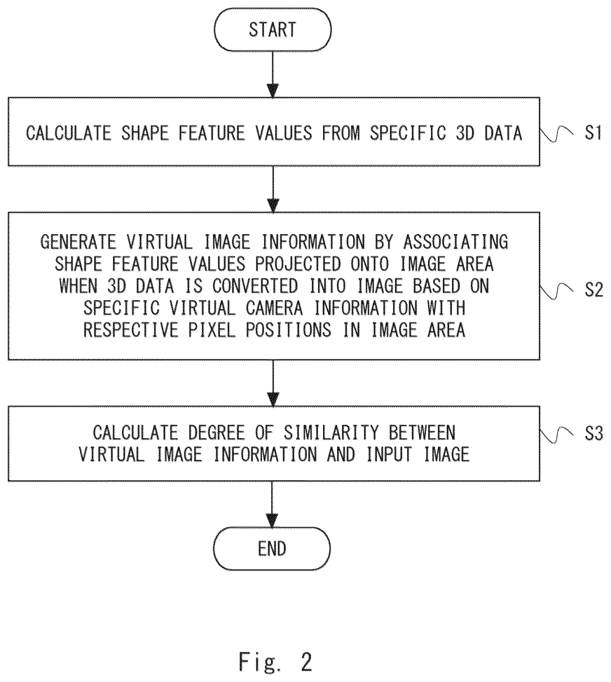

FIG. 2 is a flowchart showing a flow of a photographing position and posture estimation method. Firstly, the feature value calculation unit 11 calculates shape feature values from specific 3D data (S1). Next, the generation unit 12 generates virtual image information by associating shape feature values projected onto an image area when the 3D data is converted into an image based on specific virtual camera information with respective pixel positions in the image area (S2). Then, the similarity calculation unit 13 calculates a degree of similarity between the virtual image information and an input image (S3).

Therefore, the photographing position and posture estimation apparatus 1 can estimate, based on the degree of similarity between the virtual image information and the input image, the photographing position and posture corresponding to the input image from among a plurality pieces of virtual camera information (a plurality of candidates for photographing positions and postures). Note that when the similarity calculation unit 13 calculates a degree of similarity, it uses shape feature values associated with respective pixel positions of the virtual image information and does not use color information. Therefore, the photographing position and posture can be estimated by using 3D data containing no color information. Therefore, the accuracy of the estimation equivalent to that in the case where color information is used can be maintained. That is, the photographing position and posture estimation apparatus 1 according to the present disclosure can maintain the accuracy of the estimation of a photographing position and a photographing posture of a photographed image in the case where 3D data containing no color information is used.

Note that the photographing position and posture estimation apparatus 1 includes, as a configuration not shown in the drawing, a processor, a memory, and a storage device. Further, in the storage device, for example, a computer program in which processes in a photographing position and posture estimation method shown in FIG. 2 are implemented is stored. Further, the processor loads the computer program and the like from the storage device onto the memory, and executes the loaded computer program. In this way, the processor implements the functions of the feature value calculation unit 11, the generation unit 12, and the similarity calculation unit 13.

Alternatively, each component of the photographing position and posture estimation apparatus 1 may be implemented by dedicated hardware. Further, some or all of the components of apparatuses may be implemented by a general-purpose or dedicated circuitry, processor or the like, or a combination thereof. They may be configured by a single chip or by a plurality of chips connected through a bus. Some or all of the components of apparatuses may be implemented by a combination of the above-described circuitry or the like and the program. Further, a CPU (Central Processing Unit), a GPU (Graphics Processing Unit), an FPGA (Field-Programmable Gate Array), a quantum processor (quantum computer control chip) or the like may be used as a processor.

Further, when some or all of the components of the photographing position and posture estimation apparatus 1 are implemented by a plurality of information processing apparatuses, circuits, or the like, the plurality of information processing apparatuses, circuits, or the like may be disposed at one place in a concentrated manner or distributed over a plurality of places. For example, the information processing apparatuses, circuits, or the like may be implemented in the form of a client-server system, a cloud computing system, or the like in which components or the like are connected to each other through a communication network. Further, the functions of the photographing position and posture estimation apparatus 1 may be provided in the form of SaaS (Software as a Service).

### Second Example Embodiment

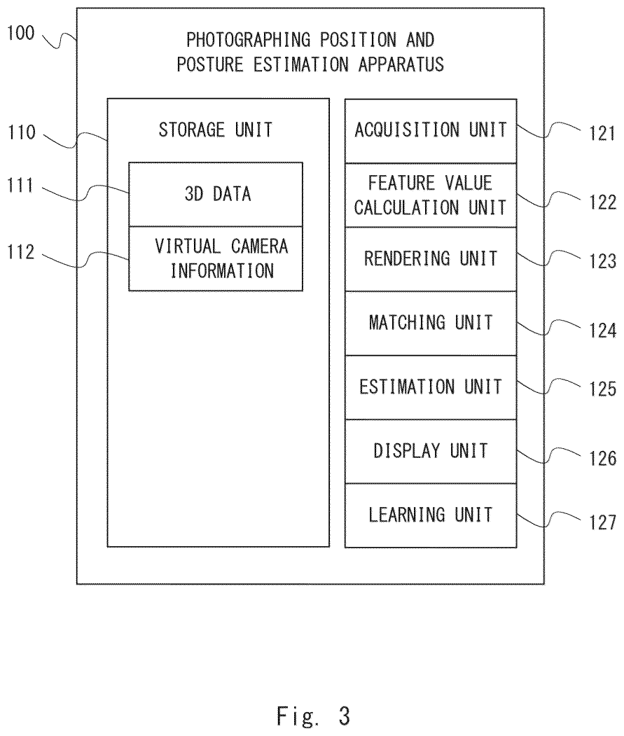

FIG. 3 is a block diagram showing a configuration of a photographing position and posture estimation apparatus 100. The photographing position and posture estimation apparatus 100 is an example of the photographing position and posture estimation apparatus 1 described above. The photographing position and posture estimation apparatus 1 includes a storage unit 110, an acquisition unit 121, a feature value calculation unit 122, a rendering unit 123, a matching unit 124, an estimation unit 125, a display unit 126, and a learning unit (or training unit) 127.

The storage unit 110 includes, for example, a nonvolatile storage device such as a flash memory and a memory such as a RAM (Random Access Memory), i.e., a volatile storage device. The storage unit 110 stores 3D data 111 and virtual camera information 112. As described above, the 3D data 111 is data (3D (three dimensions) data) representing the 3D structure of a target object. Further, the 3D data 111 may be, for example, 3D data obtained by photographing an object or the like by a LiDAR (Light Detection And Ranging) system, or 3D-CAD data (containing no color information) created at the design stage of a structure. The virtual camera information 112 is information similar to the virtual camera information in the first example embodiment described above. Further, it is assumed that two or more pieces of virtual camera information 112 is stored in the storage unit 110.

The acquisition unit 121 acquires an image obtained by photographing a target object corresponding to the 3D data 111 as an input image. The input image is an image that is used to enable the photographing position and posture estimation apparatus 100 to estimate a photographing position and a photographing posture on the 3D data 111.

The feature value calculation unit 122 is an example of the feature value calculation unit 11 described above. The feature value calculation unit 122 calculates a shape feature value for each of a plurality of data points on the 3D data 111. Note that the “shape feature values” are not limited to any specific feature values as long as they represent a distribution of 3D data 111 around a data point. It is assumed that the shape feature values are vector information having a larger number of dimensions than that of ordinary color information (e.g., the three dimensions of RGB). Therefore, the feature value calculation unit 122 calculates shape feature values at respective data points so as to represent a distribution of other data points around a specific data point of the 3D data 111. In this way, shape features of respective data points can be accurately represented by multi-dimensional vector information. For example, the feature value calculation unit 122 preferably calculates shape feature values by quantifying the shape or direction of a distribution of data points in the 3D data 111. Specifically, the feature value calculation unit 122 preferably applies a principal component analysis to the distribution of the 3D data 111 around a data point and quantifies the shape or direction of the distribution of data points in the 3D data 111 based on calculated three eigenvectors or three eigenvalues.

Alternatively, the feature value calculation unit 122 may calculate the normal vector of each data point in the 3D data 111 as a shape feature value. Alternatively, the feature value calculation unit 122 may calculate shape feature values by using a predetermined already-trained model. For example, a first model is an AI (Artificial Intelligence) model that receives 3D data around a specific data point in the 3D data 111 and outputs the shape feature value of this specific data point. For example, PointNet may be used as the first model. Further, a first trained model is preferably one that is obtained by machine-training the first model (e.g., subjecting the first model to deep learning) in such a manner that when distributions of data points in the 3D data 111 are similar to each other, their shape feature values become similar to each other. As described above, the accuracy of the calculation of shape feature values can be efficiently improved by metric learning, which is an example of unsupervised learning. Alternatively, a second model may be an AI model that receives 3D data of a predetermined object, virtual camera information, and a photographed image obtained by photographing the object, and outputs a photographing position and a photographing posture. Note that it can be said that the second model internally calculates shape feature values at respective data points. In this case, a second trained model may be an AI model that is obtained by machine-training the second model by using 3D data of a predetermined object, a photographed image obtained by photographing the object, and a photographing position and a photographing posture of the photographed image as teacher data. In this way, the accuracy of the calculation of shape feature values can also be efficiently improved by supervised learning. Note that the AI model may also be referred to as a deep learning model.

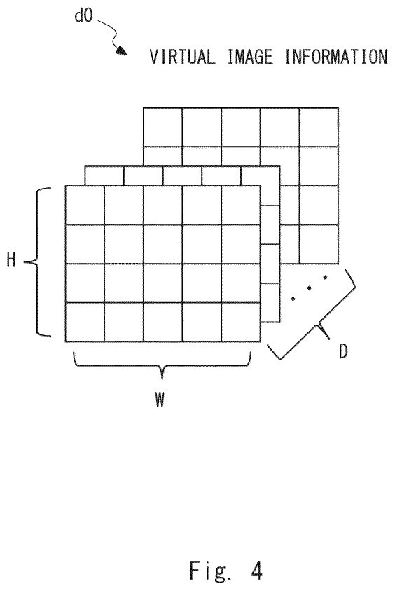

The rendering unit 123 is an example of the generation unit 12 described above. The rendering unit 123 generates virtual image information by performing rendering on the 3D data 111 by using the shape feature values based on specific virtual camera information. In other words, the rendering unit 123 specifies a set of 2D coordinates of an image area (plane) on the assumption that a target object (3D data 111) in a 3D space is photographed from the photographing position and posture of an arbitrary virtual camera, and generates virtual image information by, for example, mapping shape feature values to respective points (pixel positions) of the specified set of 2D coordinates. Further, the rendering unit 123 generates, based on a plurality of pieces of virtual camera information 112, a plurality of pieces of virtual image information corresponding to respective pieces of virtual camera information. Note that the virtual image information can be expressed as a 3D array of a height H in the image area, a width W therein, and the number D of dimensions of shape feature values (hereinafter also referred to as a shape feature value dimension number D) when the virtual image information is converted into an image. FIG. 4 is a diagram for explaining a concept of a data structure of virtual image information do. Note that the height His the number of pixels in the height direction in the image area. The width W is the number of pixels in the width direction in the image area. Note that the number of pixels of the height H and that of the width W in FIG. 4 are merely examples. The shape feature value dimension number D is the number of dimensions of the shape feature values (feature vector) calculated by the feature value calculation unit 122. The shape feature value dimension number D is preferably, for example, four or larger. That is, the shape feature values are represented by a feature value vector having four dimensions or more. Therefore, the virtual image information is information in which shape feature values (containing no color information) are associated with respective pixel positions (respective pairs each consisting of a pixel position in the height H direction and a pixel position in the width W direction). Therefore, the rendering unit 123 may be implemented by improving a technology for performing rendering on 3D data containing color information in such a manner that it refers to shape feature values at corresponding pixel positions instead of referring to color information of the 3D data.

Further, the rendering unit 123 may convert shape feature values based on the photographing positions and postures contained in the virtual camera information 112, and generate virtual image information by using the converted shape feature values. For example, in the case where the shape feature values calculated by the feature value calculation unit 122 are feature values which depend on, i.e., affected by, the rotation or translation of the 3D data 111 (e.g., normal vectors), if rendering is performed on the normal direction as they are, the absolute directions of the normals, which are, for example, westward or eastward, affects the rendering. In this case, the direction cannot be determined from the input image which is subjected to the matching when the degree of similarity is calculated. Therefore, the rendering unit 123 converts the shape feature values based on the photographing position and posture of the virtual camera information 112 so as to remove information in regard to the absolute photographing position and direction, and generates virtual image information by using the converted shape feature values. In this way, it is possible to generate more accurate virtual image information from which the influence of the absolute directions of the normals is removed.

The matching unit 124 is an example of the similarity calculation unit 13 described above. The matching unit 124 calculates a degree of similarity between each of a plurality of pieces of virtual image information and an input image. Further, the matching unit 124 may calculate a degree of similarity between the virtual image information and the input image when it acquires an image obtained by photographing an object corresponding to 3D data 111 as an input image.

The matching unit 124 performs either (M1) global matching or (M2) local matching, or both (M1) global matching and (M2) local matching. In the (M1) global matching, the feature of each of a plurality of pieces of virtual image information is compared with an input image over the entire image area in a global manner, and a degree of similarity between each of the plurality of pieces of virtual image information and the input image is thereby obtained. In the (M2) local matching, the shape feature value of each of pieces of virtual image information is compared with color information of the input image on a pixel-by-pixel basis (i.e., in a local manner), and a degree of similarity is thereby calculated on a pixel-by-pixel basis. By doing so, a corresponding relationship between pixel positions is obtained. In this process, the matching unit 124 performs matching while correcting the corresponding relationship between pixel positions as appropriate. Note that in the (M1) global matching, the photographing position and posture corresponding to the input image is roughly estimated compared with the (M2) local matching. In other words, the (M2) local matching can increase the accuracy of the estimation of the photographing position and posture corresponding to the input image compared with the (M1) global matching. However, the processing of the (M1) global matching is faster than that of the (M2) local matching. In other words, the processing cost of the (M2) local matching is higher than that of the (M1) global matching.

The matching unit 124 can be implemented by using a matching model with which it is possible to perform both the (M1) global matching and the (M2) local matching. An ordinary matching model can be considered to be an AI model that receives two images each containing color information and outputs a degree of similarity between these images. In contrast, the matching unit 124 according to the present disclosure can use an AI model that can receive virtual image information by changing, instead of color information, the channel dimension of one of input images to the dimension of shape feature values, and leaves the channel dimension of the other input image (photographed image) as it is.

The estimation unit 125 estimates a photographing position and a photographing posture corresponding to the input image, i.e., a photographing position and a photographing posture from which the input image has been taken, based on the virtual camera information and the degree of similarity. Specifically, the estimation unit 125 selects virtual image information having a higher degree of similarity from among a plurality of pieces of virtual image information, and estimates a photographing position and a photographing posture corresponding to the selected virtual image information as the photographing position and posture corresponding to the input image.

The display unit 126 displays display information including the result of the estimation of the photographing position and posture corresponding to the input image, estimated based on the degree of similarity. For example, the display unit 126 displays the display information by outputting the display information to a display device (not shown) that is provided in or connected to the photographing position and posture estimation apparatus 100. Alternatively, the display unit 126 may display the display information on the screen of a photographing terminal which has photographed the input image by transmitting the display information to the photographing terminal. Further, the display unit 126 preferably displays a virtual image obtained by converting the shape feature values associated with respective pixels of the virtual image information into color information through dimensional compression. In this way, a user can visually recognize the virtual image information containing no color information as a visualized image. Further, the display unit 126 may display the virtual image and the input image in a contrasted manner, e.g., side by side. In this way, the user can easily visually recognize the corresponding relationship between the virtual image and the input image, and can more accurately recognize the photographing position and posture. Further, the display unit 126 may display the virtual image together with the estimation result. Further, the display unit 126 may display the virtual image and the input image in a contrasted manner, e.g., side by side, together with the estimation result. In this way, the user can more accurately recognize the photographing position and posture. Note that the display unit 126 may function as an output unit that outputs the estimation result, the virtual image information, the virtual image, the input image, and the like.

The learning unit 127 machine-trains an AI model such as a shape feature value calculation model, a similarity calculation model, a first estimation model, or a second estimation model, and updates parameters of the model. The shape feature value calculation model is used for the processing performed by the feature value calculation unit 122. The similarity calculation model is used for the processing performed by the matching unit 124. The first estimation model is used for the processing performed by matching unit 124 and the estimation unit 125. The second estimation model may be used for the processing performed by any of the feature value calculation unit 122 to the estimation unit 125. Note that the photographing position and posture estimation apparatus 100 according to the present disclosure may use any one of the above-described models. Alternatively, the photographing position and posture estimation apparatus 100 may use the shape feature value calculation model and either one of the similarity calculation model and the first estimation model in combination. Alternatively, the photographing position and posture estimation apparatus 100 may use the second estimation model.

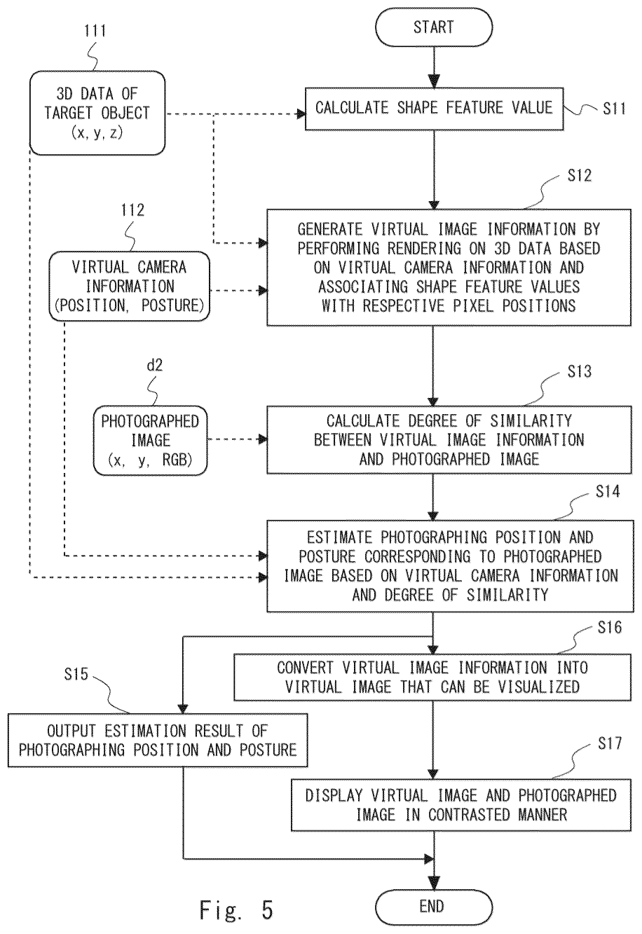

FIG. 5 is a flowchart showing a flow of a photographing position and posture estimation process. Firstly, the feature value calculation unit 122 calculates a shape feature value at each data point of the 3D data 111 (S11). Next, the rendering unit 123 generates virtual image information do by performing rendering on the 3D data 111 based on the virtual camera information 112 and associating the shape feature values with respective pixel positions (S12). Then, the matching unit 124 calculates a degree of similarity between the virtual image information do and the photographed image d2 (S13). After that, the estimation unit 125 estimates a photographing position and a photographing posture corresponding to the photographed image d2, i.e., a photographing position and a photographing posture from which the photographed image d2 has been taken, based on the virtual camera information 112 and the degree of similarity (and the 3D data 111) (S14). Then, the display unit 126 outputs the result of the estimation of the photographing position and posture (S15). Further, the display unit 126 converts the virtual image information do into a virtual image d1 that can be visualized (S16). Then, the display unit 126 displays the virtual image d1 and the photographed image d2 in a contrasted manner, e.g., side by side (S17).

### <Method for Visualizing Virtual Image Information>

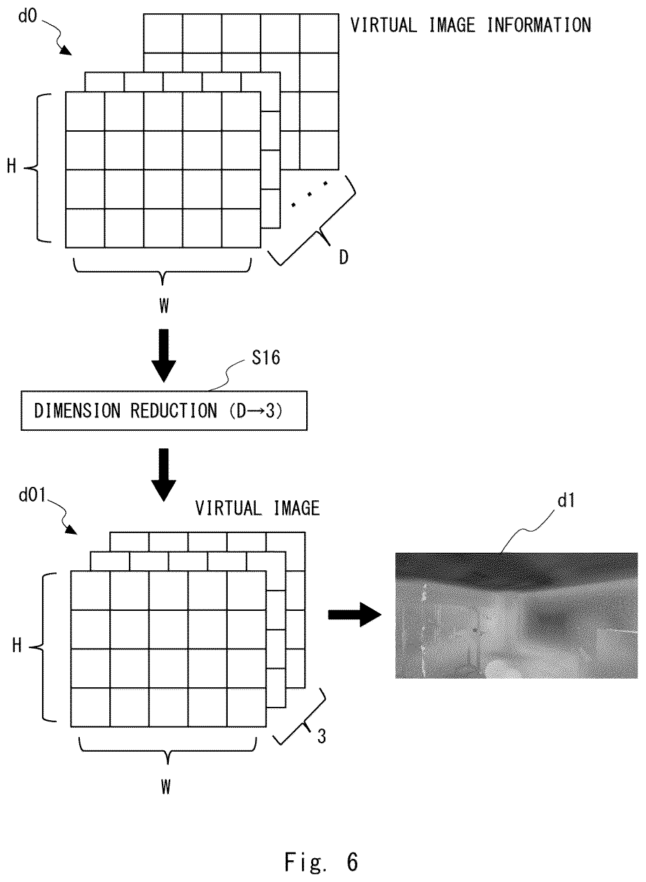

FIG. 6 is a diagram for explaining a concept of a method for visualizing virtual image information do. In the virtual image information do, as described above, feature value vectors each having a shape feature value dimension number D are associated with respective pixel positions of a set of pixels having a height H and a width W, i.e., a set of pixels in an area having a height H and a width W. As described above, the height H and the width W are merely examples, and it is assumed that the shape feature value dimension number D is four or larger. The display unit 126 converts the shape feature values into a virtual image d01 by performing a dimension reduction process. Note that the dimension reduction process is a process for converting a set of vectors each having a large number of dimensions into a set of vectors each having a small number of dimensions. Specifically, in the dimension reduction process, the conversion is performed in such a manner that vectors having similar values in the high-dimensional space are converted into vectors having similar values in the low-dimensional space. For example, principal component analysis (PCA), t-SNE (t-distributed Stochastic Neighbor Embedding), or the like can be used for the dimension reduction process. Note that the dimension reduction process may also be referred to as a dimension compression process.

In the example shown in FIG. 6, the display unit 126 interprets that the virtual image information do consists of n D-dimensional vectors (where n is expressed as “height H×width W”), so that it applies the dimension reduction process to the virtual image information do and thereby converts it into a virtual image d01 consisting of n 3D vectors (where n is expressed as “height H×width W”). Note that the converted 3D vector indicates color information, e.g., RGB. In this way, the virtual image information do can be converted into a color image format. However, the color information may be a 3D vector other than RGB or a color information vector having a number of dimensions other than three. At least the shape feature value dimension number D is larger than the number of dimensions of the converted color information. Then, the display unit 126 displays the converted virtual image d1 on the screen. In this way, the virtual image information do can be visualized. Note that through the dimension reduction process, parts of the visualized virtual image d1 that have similar colors each other represent similar values as the original shape feature values. Note that regarding the color information converted into the 3D vectors by the dimension reduction process, their pixel positions may represent heights in the 3D data by color or shading. For example, regarding the color information, red indicates a relatively high position; blue indicates a relatively low position; and green indicates a position having an intermediate height between red and blue. Further, gray indicates some object.

Note that when the dimension reduction is applied to each virtual image information, there is a case where even images of which the viewpoints of rendering are similar to each other are converted into images having different color tones. For example, there is a possible case where a wall is green in one visualized virtual image, while a wall is red in another virtual image. This is because, in the dimension reduction process, although the distance between vectors before the reduction is maintained after the reduction, the order of dimensions after the reduction (order of R, G, B) is uncertain.

Therefore, the photographing position and posture estimation apparatus 100 preferably generates a dimension reduction function by using the 3D vector data of which the high-dimensional shape feature values have already been calculated, and applies the generated function to the dimension reduction process for a plurality of pieces of virtual image information. In this way, the color tones of virtual images that have been generated and converted based on pieces of virtual camera information at viewpoints close to each other becomes similar to each other.

That is, the photographing position and posture estimation apparatus 100 generates a function for “converting one D-dimensional data into one 3D data” by performing dimensional reduction from D dimensions to three dimensions on 3D data consisting of data at N points each having D-dimensional shape feature values. Note that the photographing position and posture estimation apparatus 100 can generate the above-described function by using PCA or t-SNE technology. Then, the display unit 126 can generate a virtual image d1 by applying the function for “converting one D-dimensional data into one 3D data” to the virtual image information do, and thereby converting n D-dimensional vectors (where n is expressed as “height H×width W”) into n 3D vectors (where n is expressed as “height H×width W”).

<Example of Display of Comparison between Visualized Virtual Image and Input Image>

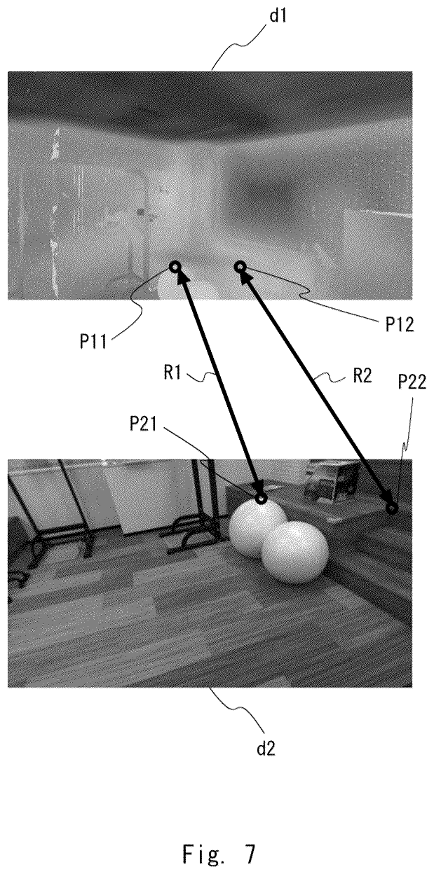

FIG. 7 shows an example of an image showing corresponding relationships between pixels estimated by local matching. A corresponding relationship R1 indicates that a pixel P11 of a virtual image d1 and a pixel P21 of a photographed image d2 are likely to be at the same location (i.e., the degree of similarity therebetween is high). Further, a corresponding relationship R2 indicates that a pixel P12 of the virtual image d1 and a pixel P22 of the photographed image d2 are likely to be at the same location (i.e., the degree of similarity therebetween is high).

### <Regarding Learning 1 (Training) of Estimation Model>

For example, the matching unit 124 preferably calculates a degree of similarity by using a third trained model which is machine-trained by using, as teacher data, each of 3D data of a predetermined object, a photographed image obtained by photographing the object, and a photographing position and a photographing posture of the photographed image, i.e., a photographing position and a photographing posture from which the photographed image has been taken. The third trained model is one that is obtained by machine-training either of the first and second estimation models described.

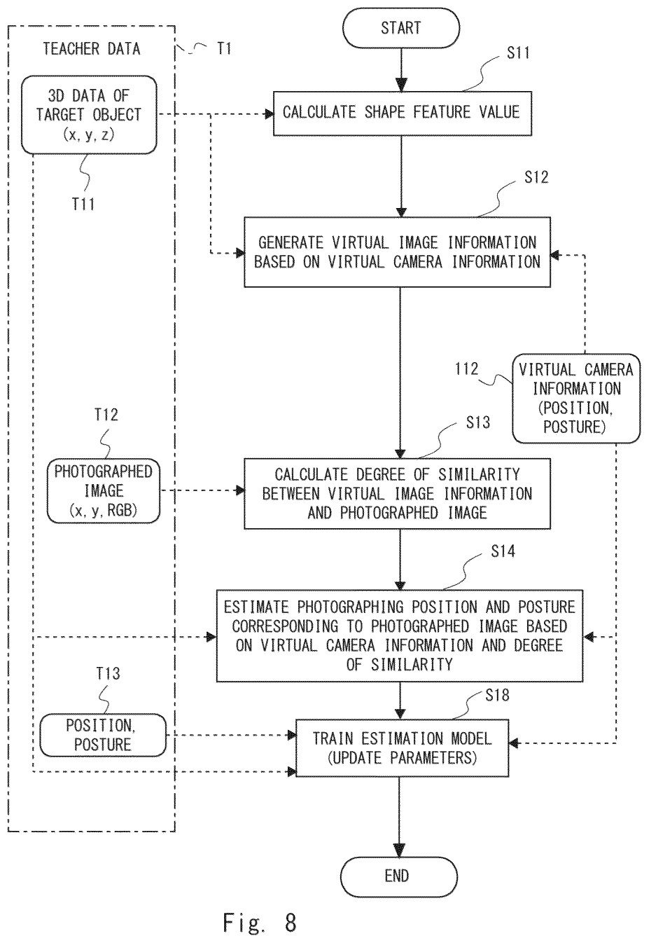

FIG. 8 is a flowchart showing a flow of a process for training a first estimation model. Teacher data Tl includes teacher 3D data T11, a photographed image T12, and a position-and-posture T13. The position-and-posture T13 is correct-answer data of a photographing position and a photographing posture when the photographed image T12 is taken. Note that the training process shown in FIG. 8 can also be applied to the second estimation model described above.

Firstly, the feature value calculation unit 122 calculates a shape feature value at each data point of the teacher 3D data T11 (S11). Next, the rendering unit 123 generates virtual image information do by performing rendering on the 3D data T11 based on the virtual camera information 112 and associating shape feature values with respective pixel positions (S12). Then, the matching unit 124 calculates a degree of similarity between the virtual image information do and the photographed image T12 by using the first estimation model (S13). After that, the estimation unit 125 estimates a photographing position and a photographing posture corresponding to the photographed image d2 based on the virtual camera information 112 and the degree of similarity (and the 3D data T11) by using the first estimation model (S14). After that, the learning unit 127 trains the first estimation model by using the teacher position-and-posture T13 (S18). In other words, the learning unit 127 evaluates the photographing position and posture estimated in the step S14 by using the teacher position-and-posture T13, and updates parameters of the first estimation model. Specifically, the learning unit 127 updates the parameters of the first estimation model so that the photographing position and posture estimated in the step S14 get closer to the teacher position-and-posture T13. Note that the learning unit 127 may repeat the steps S13, S14 and S18 until the training result satisfies a predetermined condition. The predetermined condition is, for example, but not limited to, the number of repetitions or the fact that the error between the estimation result and the teacher data is equal to or lower than a threshold.

Note that when the step S13 is (M1) global matching, the learning unit 127 updates the parameters of the first estimation model in such a manner that the calculated degree of similarity becomes high when the degree of overlapping between the photographing range from the position and posture of the virtual camera information 112 and that from the teacher position-and-posture T13 is large. Further, when the step S13 is (M2) local matching, the learning unit 127 calculates a corresponding relationship R01 between a pixel(s) representing a position in the virtual image information do and a pixel(s) representing the same position in the teacher photographed image T12 based on the virtual camera information 112, the teacher position-and-posture T13, and the 3D data T11. Then, the learning unit 127 updates the parameters of the first estimation model so that a corresponding relationship R02 between pixels calculated in the step S13 gets closer to the corresponding relationship R01.

### <Regarding Learning 2 (Training) of Estimation Model>

In general, it is often expensive or difficult to prepare high-quality teacher 3D data. Therefore, a positional relationship between two or more virtual cameras may be taken into consideration in the training of an estimation model.

In this case, when the 3D data 111 is converted into an image, the rendering unit 123 preferably generates virtual image information for an area corresponding to a common photographing range of first virtual camera information and second virtual camera information. That is, when virtual image information is generated from the first virtual camera information, the rendering unit 123 defines a common photographing range of the first virtual camera information and the second virtual camera information as an area on which rendering is performed. In this way, it is possible to reproduce a missing part in image information that is caused by occlusion when 3D data is created in a simulative manner, and thereby to improve the robustness of the estimation model.

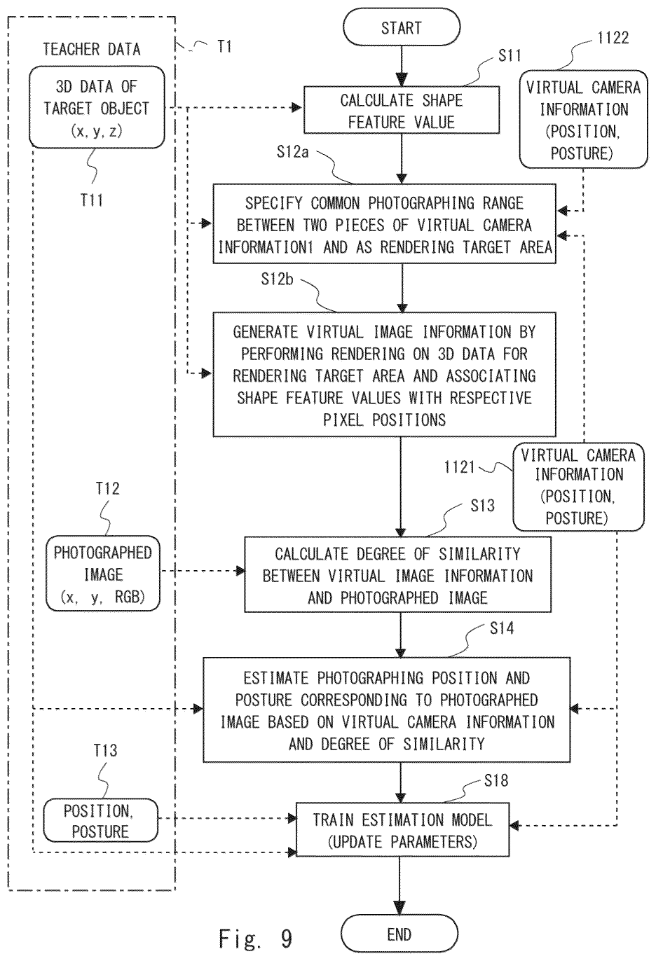

FIG. 9 is a flowchart showing a flow of a process for training a first estimation model. Firstly, the feature value calculation unit 122 calculates a shape feature value at each data point of the teacher 3D data T11 (S11). Next, the rendering unit 123 specifies a common photographing range of two pieces of virtual camera information 1121 and 1122 as a rendering target area (S12a). Then, the rendering unit 123 generates virtual image information do by performing rendering on the 3D data T11 for the rendering target area and associating shape feature values with respective pixel positions (S12b). After that, the photographing position and posture estimation apparatus 100 performs processes in the steps S13, S14 and S18 in the same manner as in FIG. 8 described above.

### <Regarding Learning 3 (Training) of Estimation Model>

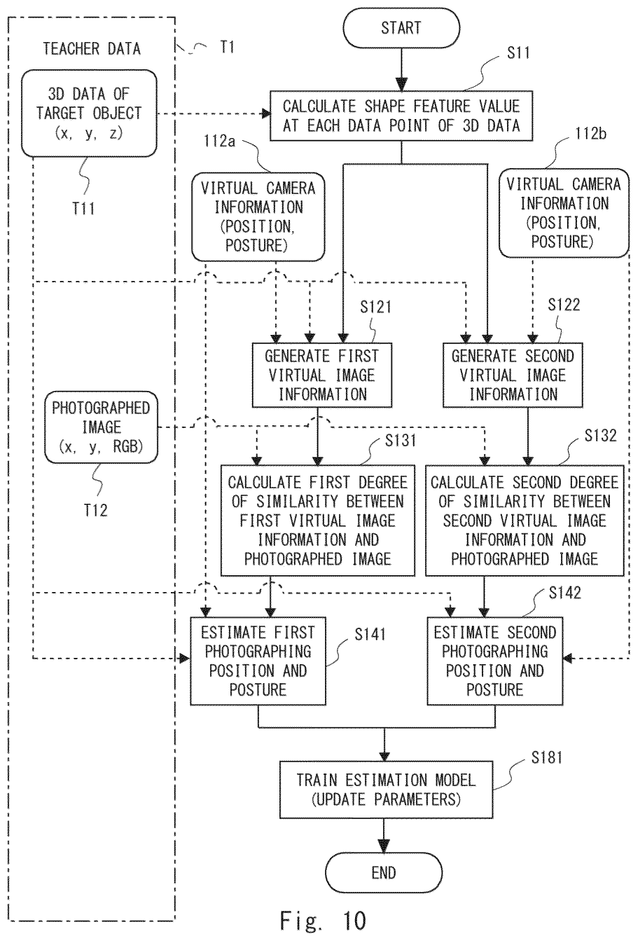

A metric learning approach may be used for training an estimation model. FIG. 10 is a flowchart showing a flow of a process for training a first estimation model. As a premise, it is assumed that the photographing range from the position and posture of virtual camera information 112a is similar to that from the teacher position-and-posture T13. Further, it is assumed that the photographing range from the position and posture of virtual camera information 112b is not similar to that from the teacher position-and-posture T13. Firstly, the feature value calculation unit 122 calculates a shape feature value at each data point of the teacher 3D data T11 (S11).

Next, the rendering unit 123 generates first virtual image information from the 3D data T11 based on the virtual camera information 112a as described above (S121). Then, the matching unit 124 calculates a degree of similarity between the first virtual image information and the photographed image T12 by using the first estimation model (S131). After that, the estimation unit 125 estimates a first photographing position and posture (e.g., a first pair of a photographing position and a photographing posture) corresponding to the photographed image d2 based on the virtual camera information 112a and the degree of similarity (and the 3D data T11) by using the first estimation model (S141).

Further, in parallel with the steps S121, S131 and S141, the rendering unit 123 generates a second virtual image information from the 3D data T11 based on the virtual camera information 112b as described above (S122). Then, the matching unit 124 calculates a degree of similarity between the second virtual image information and the photographed image T12 by using the first estimation model (S132). After that, the estimation unit 125 estimates a second photographing position and posture (e.g., a second pair of a photographing position and a photographing posture) corresponding to the photographed image d2 based on the virtual camera information 112b and the degree of similarity (and the 3D data T11) by using the first estimation model (S142).

After that, the learning unit 127 trains the first estimation model by using the first photographing position and posture and the second photographing position and posture (S181). In other words, the learning unit 127 evaluates the teacher photographed image d2 in the feature value space and updates the parameters of the first estimation model so that the degree of similarity between the photographed image d2 and the first virtual image information becomes higher than the degree of similarity between they photographed image d2 and the second virtual image information. That is, the learning unit 127 performs the training so that the first virtual image information gets closer to the teacher photographed image d2 than the second virtual image information does.

As described above, in the technology disclosed in Patent Literature 1, in the case where a photographing position and a photographing posture on the 3D of a specific target object created in advance is estimated from an image of the target object photographed by a camera, it is necessary, as a premise, that color information (texture information or the like) is contained in the 3D data. However, an expensive apparatus, e.g., a camera equipped with a 3D sensor, is required to prepare such 3D data containing color information in advance. In contrast to this, in the present disclosure, even when 3D data containing no color information is used, the accuracy of the estimation of a photographing position and a photographing posture can be maintained by using shape feature values. Therefore, since the 3D data required is one that contains no color information and hence can be prepared by using an inexpensive system, the introduction cost can be reduced. For example, the photographing position and posture estimation apparatus according to the present disclosure can use 3D data obtained by photographing an object or the like by an inexpensive LiDAR system (one equipped with no camera) like the one adopted in an MMS (Mobile Mapping System) or the like. Alternatively, the photographing position and posture estimation apparatus according to the present disclosure can use 3D-CAD data (containing no color information) created at the design stage of a structure. Further, regarding the input image used in the present disclosure, it is possible to use a photograph taken by an infrared camera or the like, i.e., image data containing no color information.

Further, since the photographing position and posture estimation apparatus according to the present disclosure converts 3D data into an image based on virtual camera information, it is possible to generate virtual image information using shape feature values including an expression in which the depth is collapsed, i.e., flattened, as in the case of the input image. Therefore, the matching between the virtual image information and the input image can be easily performed.

### Example 2-1

In the step S13 in FIG. 5 described above, the matching unit 124 may perform the (M1) global matching process, but may not perform the (M2) local matching process. In this case, in the step S14, the estimation unit 125 preferably selects virtual camera information having the highest degree of overall similarity between the virtual image information and the input image from among the plurality of pieces of virtual camera information, and estimates the photographing position and posture corresponding to the selected virtual camera information as the photographing position and posture corresponding to the input image.

### Example 2-2

In the step S13 in FIG. 5 described above, the matching unit 124 may perform the (M2) local matching process without performing the (M1) global matching process. In this case, in the step S14, the estimation unit 125 preferably associates pixel positions in the input image with coordinates in the 3D data based on the corresponding relationship of pixel positions obtained in the step M2, and estimates the photographing position and posture corresponding to the input image by PnP (Perspective-n-Point) or the like. For example, when it is estimated that the photographing ranges of the virtual image information and the input image overlap each other, it is possible to estimate a precise position and a precise posture corresponding to the input image. Further, when the (M2) local matching process is performed, the matching unit 124 may use the photographing position information of the input image together with the virtual camera information. In this case, the processing cost can be reduced without performing the (M1) global matching process.

### Example 2-3

The photographing position and posture estimation apparatus 100 may use the (M1) global matching process and the (M2) local matching process in combination. For example, in the step S13 in FIG. 5 described above, the matching unit 124 may first perform the (M1) global matching and then perform the (M2) local matching. In this way, in the Example 2-3, the processing efficiency can be improved and the accuracy of the estimation can be thereby improved compared with Examples 2-1 and 2-2.

Further, when a plurality of pieces of virtual camera information are generated, virtual camera information in which, for example, the shape of a 3D data part within the photographing range of the virtual camera information is characteristic may be selectively (or preferentially) generated. In this way, the processing efficiency can be further improved and hence the accuracy of the estimation can be further improved.

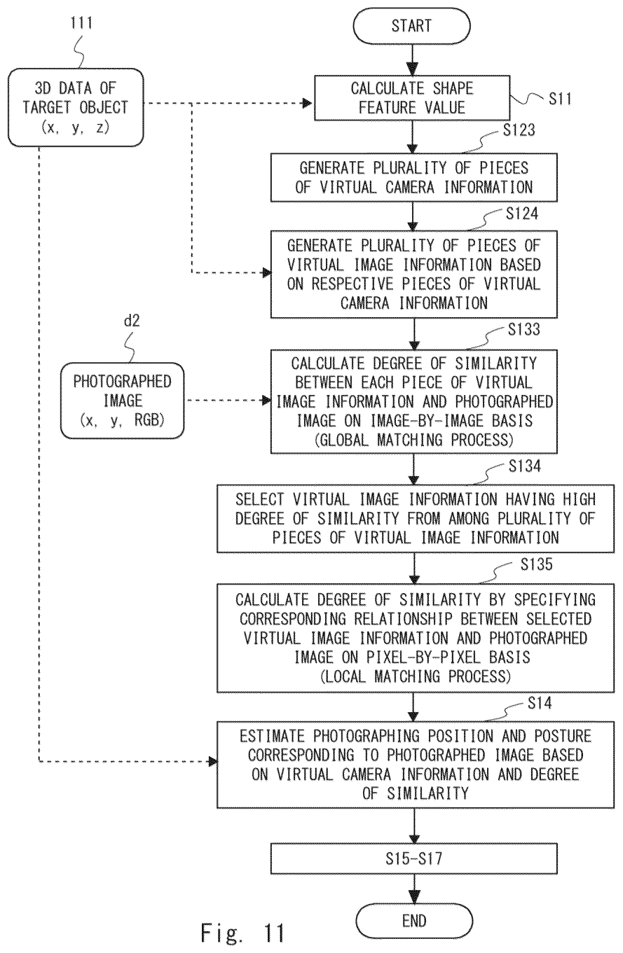

FIG. 11 is a flowchart showing a flow of a photographing position and posture estimation process when a global matching process and a local matching process are used in combination. Firstly, the feature value calculation unit 122 calculates a shape feature value at each data point of the 3D data 111 (S11). Further, the rendering unit 123 generates a plurality of pieces of virtual camera information (S123). Note that the order of steps S11 and S123 may be reversed, or they may be performed in parallel with each other. In the step S123, the rendering unit 123 generates a plurality of pieces of virtual camera information in such a manner that a data point(s) of which the shape is more characteristic than those of other data points among the data points of the 3D data 111 is included in the photographing range.

Note that examples of the method for determining the degree of the characteristic of the shape of a 3D data part within the photographing range of the virtual camera information include, but are not limited to, the following methods. For example, it may be a method for determining whether or not the distance from the photographing position and posture of the virtual camera information to the target 3D data surface is equal to or higher than a predetermined value. Alternatively, it may be a method for determining whether or not the degree of scattering of the distribution of normals within the photographing range is equal to or higher than a predetermined value. Alternatively, it may be a method for determining whether or not the number of pieces of contour information included in the 3D data within the photographing range is equal to or higher than a predetermined value.

Then, the rendering unit 123 generates a plurality of pieces of virtual image information corresponding to respective pieces of virtual camera information based on the respective pieces of virtual camera information (S124). Then, the matching unit 124 calculates the degree of similarity between each piece of virtual image information and the input image as being calculated in the steps S133 to S135.

That is, the matching unit 124 calculates the degree of similarity between each piece of virtual image information and the photographed image d2 on an image-by-image basis (S133). That is, the matching unit 124 performs the (M1) global matching process. Then, the matching unit 124 selects virtual image information having a high degree of similarity from among the plurality of pieces of virtual image information (S134). Then, the matching unit 124 calculates a degree of similarity by specifying a corresponding relationship between the selected virtual image information and the photographed image on a pixel-by-pixel basis (S135). That is, the matching unit 124 performs the (M2) local matching process. After that, the estimation unit 125 estimates a photographing position and a photographing posture corresponding to the photographed image d2 based on the virtual camera information 112 and the degree of similarity calculated in the step S135 (and the 3D data 111) (S14). After that, the photographing position and posture estimation apparatus 100 performs processes in steps S15, S16 and S17 in the same manner as in FIG. 5 described above.

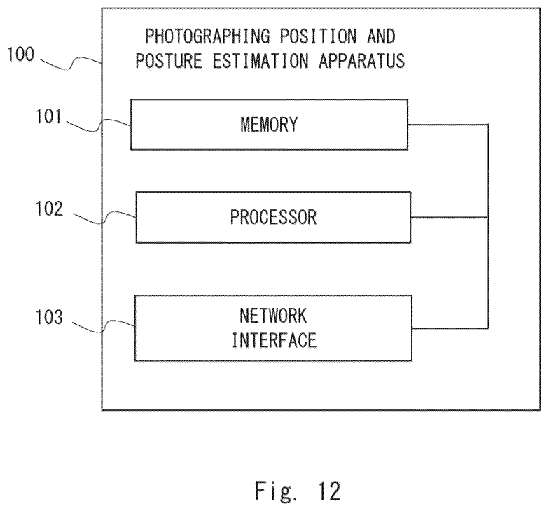

FIG. 12 is a block diagram showing a hardware configuration of the photographing position and posture estimation apparatus 100. The photographing position and posture estimation apparatus 100 includes a memory 101, a processor 102, and a network interface 103.

The memory 101 is formed by a combination of a volatile memory and a non-volatile memory. The volatile memory is, for example, a volatile storage device such as RAM, and is a storage area for temporarily holding information when the processor 102 operates. The nonvolatile memory is, for example, a nonvolatile storage device such as a hard disk drive or a flash memory. In the memory 101, at least a computer program in which processes performed by photographing position and posture estimation apparatus 100 according to the present disclosure are implemented is stored. Note that the memory 101 may include a storage disposed away from the processor 102. In this case, the processor 102 may access the memory 101 through an I/O (input/output) interface (not shown).

The processor 102 is a control apparatus for controlling each component/structure of the photographing position and posture estimation apparatus 100. The processor 102 loads software (computer program) from the memory 101 and executes the loaded software. In this way, the processor 102 implements the functions of the acquisition unit 121, the feature value calculation unit 122, the rendering unit 123, the matching unit 124, the estimation unit 125, the display unit 126, and the learning unit 127. In other words, the processor 102 performs processes in a photographing position and posture estimation method according to the present disclosure. The processor 102 may be, for example, a microprocessor, an MPU (Multi Processing Unit), or a CPU (Central Processing Unit). Further, the processor 102 may include a plurality of processors.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The network interface 103 may be used to communicate with a network node. The network interface 103 may include, for example, a network interface card (NIC) compliant with IEEE 802.3 series. IEEE stands for Institute of Electrical and Electronics Engineers. Further, the network interface 103 may include wireless LAN (Local Area Network), wired LAN, Wi-Fi (Registered Trademark), Bluetooth (Registered Trademark), and the like.

### Third Example Embodiment

Note that when an image data is taken in a state in which the camera or the like is close to the target object, the shape within the photographing range rarely changes in most cases. Therefore, it could be difficult to estimate a photographing position and a photographing posture using shape feature values. Therefore, it is preferable to automatically select, from among a plurality of input images obtained by photographing the same target object, a photographed image that was taken from a position further from the target object, and estimate a photographing position and a photographing posture corresponding to a photographed image taken from a position closer to the target object by using the result of the estimation of the photographing position and posture corresponding to the photographed image taken from the further position. Specifically, the photographing position and posture estimation apparatus according to the third example embodiment further includes a selection unit in addition to the components/structures of the photographing position and posture estimation apparatus 100 shown in FIG. 3.

The selection unit selects, of two input images taken at different distances from the object corresponding to the 3D data, one of the images including more diverse pieces of shape information as a first input image, and selects the other image as a second input image. Note that the selection unit may select an image by determining shape information included in the image based on, for example, the number of line segments included in the image data and/or the magnitudes of changes in depth values obtained by performing monocular depth estimation.

Further, the estimation unit 125 estimates a first photographing position and posture (e.g., a first pair of a photographing position and a photographing posture) corresponding to the first input image based on the degree of similarity between the virtual image information and the first input image, and the virtual image information. Then, the estimation unit 125 estimates a relative photographing position and posture between the first input image and the second input image, i.e., between the photographing position and posture corresponding to the first input image and the photographing position and posture corresponding to the second input image. Note that for the process for estimating a relative photographing position and posture, technologies such as a homography conversion and Visual-SLAM can be used. Then, the estimation unit 125 estimates a second photographing position and posture (e.g., a second pair of a photographing position and a photographing posture) corresponding to the second input image based on the first photographing position and posture and the relative photographing position and posture. Note that the rest of the configuration of the photographing position and posture estimation apparatus according to the third example embodiment is similar to that shown in FIG. 3 described above, and therefore redundant descriptions and illustrations will be omitted as appropriate.

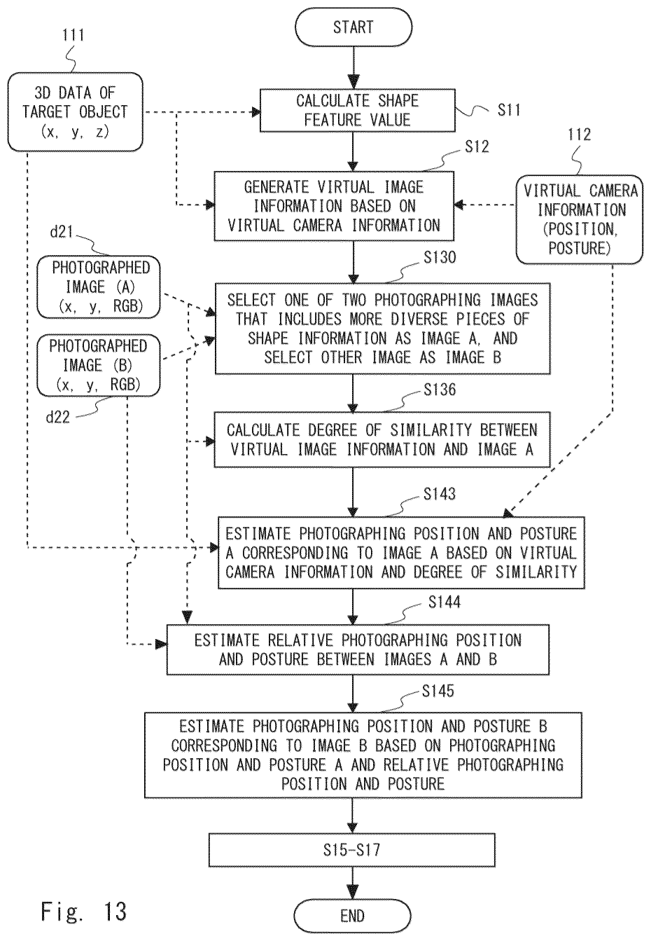

FIG. 13 is a flowchart showing a flow of a photographing position and posture estimation process performed for two input images. After steps S11 and S12, the selection unit selects one of two photographing images that includes more diverse pieces of shape information as an image A (e.g., a photographed image d21), and selects the other image as an image B (e.g., a photographed image d22) (S130). Then, the matching unit 124 calculates a degree of similarity between the virtual image information do and the image B (S13). Then, the estimation unit 125 estimates a photographing position and posture A corresponding to the image A based on the virtual camera information 112 and the degree of similarity (S143). Then, the estimation unit 125 estimates a relative photographing position and posture between the images A and B (S144). After that, the estimation unit 125 estimates a photographing position and posture B corresponding to the image B based on the photographing position and posture A and the relative photographing position and posture (S145). After that, the photographing position and posture estimation apparatus 100 performs processes in steps S15, S16 and S17 in the same manner as in FIG. 5 described above.

As described above, in the third example embodiment, when a plurality of photographed images are provided, an image including more diverse pieces of shape information is automatically selected as an image A. Therefore, it is possible to improve the accuracy of the estimation of the photographing position and posture corresponding to a photographed image taken from a position closer to the object or the like.

### Fourth Example Embodiment

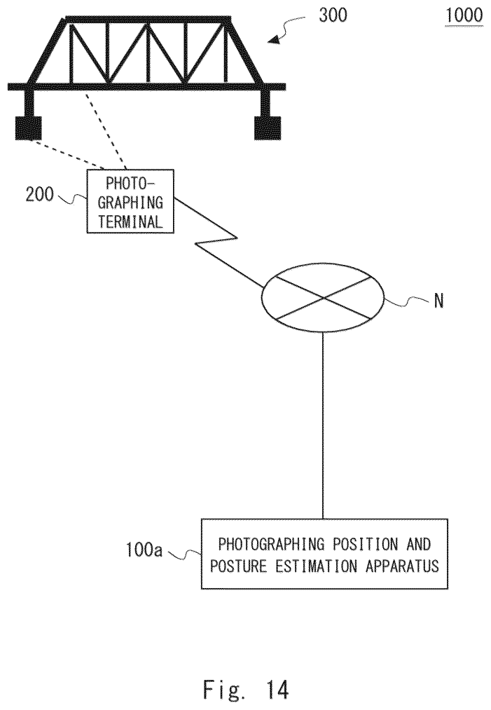

FIG. 14 is a block diagram showing a configuration of a photographing position and posture estimation system 1000. The photographing position and posture estimation system 1000 includes a photographing terminal 200 and a photographing position and posture estimation apparatus 100a. The photographing terminal 200 and the photographing position and posture estimation apparatus 100a are connected to each other through a network N so that they can communicate with each other. Note that the network N is a wired or wireless communication line. The photographing terminal 200 is an information processing apparatus including a camera, a display screen, and a radio communication function. The photographing terminal 200 is, for example, a mobile terminal such as a smartphone or a tablet terminal. The photographing terminal 200 photographs a target object 300 from an arbitrary photographing position and an arbitrary photographing posture according to an operation performed by a user who possesses the photographing terminal 200, and transmits a photographing position and posture estimation request including the photographed image to the photographing position and posture estimation apparatus 100a. Further, the photographing terminal 200 receives the result of the estimation from the photographing position and posture estimation apparatus 100a and displays the received estimation result on the display screen. Further, the photographing terminal 200 may receive the result of a comparison between the virtual image and the photographed image from the photographing position and posture estimation apparatus 100a and display the received comparison result on the display screen.

The photographing position and posture estimation apparatus 100a has a configuration similar to that of the photographing position and posture estimation apparatus 100 shown in FIG. 3 described above, and therefore redundant descriptions and illustrations will be omitted as appropriate. However, the acquisition unit 121 of the photographing position and posture estimation apparatus 100a receives the photographing position and posture estimation request including the photographed image from the photographing terminal 200 and thereby acquires the photographed image included in the estimation request as an input image. Further, when the matching unit 124 of the photographing position and posture estimation apparatus 100a receives an image obtained by photographing an object by the photographing terminal 200 as an input image, it calculates a degree of similarity between the virtual image information and the input image. Further, the display unit 126 of the photographing position and posture estimation apparatus 100a transmits the result of the estimation to the photographing terminal 200 and makes the photographing terminal 200 display the received estimation result. Further, the display unit 126 may also transmit the result of a comparison between the virtual image and the photographed image to the photographing terminal 200 and make the photographing terminal 200 display the received comparison result.

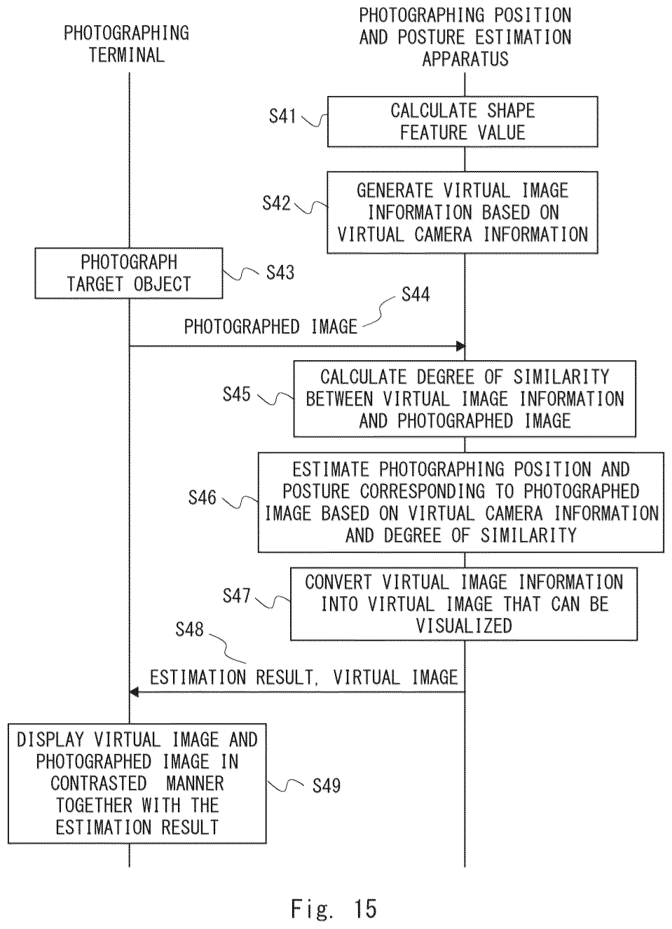

FIG. 15 is a sequence chart showing a flow of a photographing position and posture estimation process. Firstly, similarly to the step S11 in FIG. 5, the feature value calculation unit 122 calculates a shape feature value at each data point of the 3D data 111 (S41). Next, similarly to the step S12 in FIG. 5, the rendering unit 123 generates virtual image information based on the virtual camera information 112 (S42).

Further, the photographing terminal 200 photographs a target object 300 (S43). Then, the photographing terminal 200 transmits a photographing position and posture estimation request including the photographed image to the photographing position and posture estimation apparatus 100a through the network N (S44). In response to this, the acquisition unit 121 of the photographing position and posture estimation apparatus 100a receives the estimation request from the photographing terminal 200 through the network N, and thereby acquires the photographed image included in the estimation request as an input image.

Next, the matching unit 124 calculates a degree of similarity between the virtual image information and the photographed image (acquired from the photographing terminal 200) (S45). Then, the estimation unit 125 estimates a photographing position and a photographing posture corresponding to the photographed image based on the virtual camera information and the degree of similarity (S46). Then, the display unit 126 converts the virtual image information into a virtual image that can be visualized as described above (S47). After that, the display unit 126 transmits the estimation result, the virtual image, a corresponding relationship between the virtual image and the photographed image, and the like to the photographing terminal 200 through the network N (S38). In response to this, the photographing terminal 200 receives the estimation result, the virtual image, the corresponding relationship between the virtual image and the photographed image, and the like from the photographing position and posture estimation apparatus 100a through the network N. Then, the photographing terminal 200 displays the virtual image and the photographed image in a contrasted manner, e.g., side by side, together with the estimation result (S49).

Note that the photographing position and posture estimation apparatus 100a may output the estimation result and the like to another information processing apparatus in addition to the photographing terminal 200. Alternatively, the photographing position and posture estimation apparatus 100a may output the estimation result and the like to another information processing apparatus instead of transmitting it to the photographing terminal 200. Alternatively, the photographing position and posture estimation apparatus 100a may register (output) the estimation result and the like in the storage unit 110 or an external storage device.

Further, the functions of the photographing position and posture estimation apparatus 100a and the photographing terminal 200 in the photographing position and posture estimation system 1000 may be distributed in a manner different from the distribution described above. For example, the photographing terminal 200 may include a storage unit 110, an estimation unit 125, and a display unit 126. In this case, the photographing position and posture estimation apparatus 100a preferably transmits the degree of similarity (or corresponding relationship between pixel positions) calculated by the matching unit 124 and the virtual image to the photographing terminal 200. Then, the estimation unit 125 of the photographing terminal 200 may estimate a photographing position and a photographing posture based on the received degree of similarity. After that, the photographing terminal 200 preferably displays the information or the like in the step S49. Alternatively, the photographing terminal 200 may include a storage unit 110, a matching unit 124, an estimation unit 125, and a display unit 126. Further, the photographing position and posture estimation apparatus 100a may transmit the virtual image information, instead of the virtual image, to the photographing terminal 200. In this case, the photographing terminal 200 preferably converts the received virtual image information into a virtual image that can be visualized, and display the converted virtual image.

As described above, effects similar to those obtained in the above-described Example 2 or 3 can also be obtained by this example embodiment.

### Other Embodiments

Although the present disclosure is described above with reference to example embodiments, the present disclosure is not limited to the above-described example embodiments. Various modifications that can be understood by those skilled in the art can be made to the configuration and details of the present disclosure within the scope of the disclosure. Further, the example embodiments may be combined with one another as appropriate.

Each of the drawings is merely an example for explaining one or more example embodiments. Each of the drawings is not associated with only one particular example embodiment, but may be associated with one or more other example embodiments. As will be appreciated by those skilled in the art, various features or steps described with reference to any one of the drawings may be combined with features or steps shown in one or more other figures to, for example, create an example embodiment that is not explicitly shown or described in the present disclosure. Not all of the features or steps shown in any one of the drawings are required to explain an example embodiment, and some of the features or steps may be omitted. The order of the steps described in any one of the drawings may be changed as appropriate.

The whole or part of the example embodiments disclosed above can be described as, but not limited to, the following supplementary notes.

### (Supplementary Note A1)

A photographing position and posture estimation apparatus comprising:
feature value calculation means for calculating shape feature values from specific 3D (three-dimensional) data;
generation means for generating virtual image information by associating the shape feature values projected onto an image area when the 3D data is converted into an image based on specific virtual camera information with respective pixel positions in the image area; and
similarity calculation means for calculating a degree of similarity between the virtual image information and an input image.

### (Supplementary Note A2)

The photographing position and posture estimation apparatus described in Supplementary note A1, wherein the generation means converts the shape feature values based on a photographing position and a photographing posture included in the virtual camera information, and generates the virtual image information by using the converted shape feature values.

### (Supplementary Note A3)

The photographing position and posture estimation apparatus described in Supplementary note A1 or A2, wherein the feature value calculation means calculates the shape feature values at respective data points so as to express a distribution of other data points around a specific data point of the 3D data.

### (Supplementary Note A4)

The photographing position and posture estimation apparatus described in any one of Supplementary notes A1 to A3, wherein the generation means:
generates a plurality of pieces of virtual camera information in such a manner that a data point of which a shape is more characteristic than those of other data points among the data points of the 3D data is included in a photographing range;
generates a plurality of pieces of virtual image information corresponding to respective pieces of virtual camera information based on the respective pieces of virtual camera information, and
the similarity calculation means calculates a degree of similarity between each of the plurality of pieces of virtual image information and the input image.

### (Supplementary Note A5)

The photographing position and posture estimation apparatus described in any one of Supplementary notes A1 to A4, wherein the generation means generates the virtual image information for an area corresponding to a common photographing range of first virtual camera information and second virtual camera information when the 3D data is converted into an image.

### (Supplementary Note A6)

The photographing position and posture estimation apparatus described in any one of Supplementary notes A1 to A5, further comprising:
selection means for selecting, of two input images taken at different distances from an object corresponding to the 3D data, one of the images including more diverse pieces of shape information as a first input image, and selecting the other image as a second input image; and
estimation means for:
estimating a first photographing position and posture corresponding to the first input image based on a degree of similarity between the virtual image information and the first input image, and the virtual image information;
estimating a relative photographing position and posture between the first input image and the second input image; and
estimating a second photographing position and posture corresponding to the second input image based on the first photographing position and posture and the relative photographing position and posture.

### (Supplementary Note A7)

The photographing position and posture estimation apparatus described in any one of Supplementary notes A1 to A6, further comprising display means for displaying a virtual image in which the shape feature values associated with the respective pixels of the virtual image information are converted into color information through dimensional compression.

### (Supplementary Note A8)

The photographing position and posture estimation apparatus described in Supplementary note A7, wherein the display means displays the virtual image and the input image in a contrasted manner.

### (Supplementary Note A9)

The photographing position and posture estimation apparatus described in Supplementary note A7 or A8, wherein the display means displays the virtual image together with a result of the estimation of the photographing position and posture corresponding to the input image, estimated based on the degree of similarity.

### (Supplementary Note A10)

The photographing position and posture estimation apparatus described in Supplementary note A3, wherein the feature value calculation means calculates the shape feature values by quantifying a shape or a direction of a distribution of data points in the 3D data.

### (Supplementary Note A11)

The photographing position and posture estimation apparatus described in Supplementary note A3, wherein the feature value calculation means calculates a normal vector at each data point of the 3D data as the shape feature value.

### (Supplementary Note A12)

The photographing position and posture estimation apparatus described in Supplementary note A3, wherein the feature value calculation means calculates the shape feature values by using a first trained model, the first trained model being obtained by machine-training a first model in such a manner when distributions of data points in 3D data are similar to each other, their shape feature values become similar to each other, the first model being configured to receive 3D data around a specific data point in the 3D data and output the shape feature value of this data point.

### (Supplementary Note A13)

The photographing position and posture estimation apparatus described in Supplementary note A3, wherein the feature value calculation means calculates the shape feature values by using a second trained model, the second trained model being machine-trained by using, as teacher data, each of 3D data of a predetermined object, a photographed image obtained by photographing the object, and a photographing position and a photographing posture corresponding to the photographed image.

### (Supplementary Note A14)

The photographing position and posture estimation apparatus described in any one of Supplementary notes A1 to A13, wherein the similarity calculation means calculates the degree of similarity by using a third trained model, the third trained model being machine-trained by using, as teacher data, each of 3D data of a predetermined object, a photographed image obtained by photographing the object, and a photographing position and a photographing posture corresponding to the photographed image.

### (Supplementary Note A15)

The photographing position and posture estimation apparatus described in any one of Supplementary notes A1 to A14, wherein
the similarity calculation means calculates the degree of similarity when an image obtained by photographing an object corresponding to the 3D data is acquired as the input image, and
the photographing position and posture estimation apparatus further comprises estimation means for estimating the photographing position and posture corresponding to the input image based on the virtual camera information and the degree of similarity.

### (Supplementary Note B1)

A photographing position and posture estimation system comprising:
a photographing terminal; and
a photographing position and posture estimation apparatus connected to the photographing terminal so that they can communicate with each other, wherein
the photographing position and posture estimation apparatus is configured to:
calculate shape feature values from 3D data of a specific object;
generate virtual image information by associating the shape feature values projected onto an image area when the 3D data is converted into an image based on virtual camera information with respective pixel positions in the image area;
calculate, when the photographing terminal receives an image obtained by photographing the object as an input image, a degree of similarity between the virtual image information and the input image;
estimate a photographing position and a photographing posture corresponding to the input image based on the virtual camera information and the degree of similarity; and
return the estimated photographing position and posture to the photographing terminal.

### (Supplementary Note C1)

A photographing position and posture estimation method wherein, a computer:
calculates shape feature values from specific 3D data;
generates virtual image information by associating the shape feature values projected onto an image area when the 3D data is converted into an image based on specific virtual camera information with respective pixel positions in the image area; and
calculates a degree of similarity between the virtual image information and an input image.

### (Supplementary Note D1)

A photographing position and posture estimation program for causing a computer to perform:
a process for calculating shape feature values from specific 3D data;
a process for generating virtual image information by associating the shape feature values projected onto an image area when the 3D data is converted into an image based on specific virtual camera information with respective pixel positions in the image area; and
a process for calculating a degree of similarity between the virtual image information and an input image.

Some or all of the elements (e.g., structures and functions) described in Supplementary notes A2 to A15 that are dependent on Supplementary note A1 {e.g., apparatus} can be dependent on Supplementary note B1 {e.g., system}, Supplementary note C1 {e.g., method} and Supplementary note D1 {e.g., program} by the same dependency relationships as those in Supplementary notes A2 to A15.

Some or all of the elements described in any of the supplementary notes can be applied to various types of hardware, software, recording means for recording software, systems, and methods.

What is claimed is:

1. A photographing position and posture estimation apparatus comprising:
at least one memory storing instructions; and
at least one processor configured to execute the instructions to:
calculate shape feature values from specific 3D (three-dimensional) data;
generate virtual image information by associating the shape feature values projected onto an image area when the 3D data is converted into an image based on specific virtual camera information with respective pixel positions in the image area; and
calculate a degree of similarity between the virtual image information and an input image.

2. The photographing position and posture estimation apparatus according to claim 1, wherein the at least one processor is further configured to execute the instructions to convert the shape feature values based on a photographing position and a photographing posture included in the virtual camera information, and generate the virtual image information by using the converted shape feature values.

3. The photographing position and posture estimation apparatus according to claim 1, wherein at least one processor is further configured to execute the instructions to calculate the shape feature values at respective data points so as to express a distribution of other data points around a specific data point of the 3D data.

4. The photographing position and posture estimation apparatus according to claim 1, wherein the at least one processor is further configured to execute the instructions to:
generate a plurality of pieces of virtual camera information in such a manner that a data point of which a shape is more characteristic than those of other data points among the data points of the 3D data is included in a photographing range;
generate a plurality of pieces of virtual image information corresponding to respective pieces of virtual camera information based on the respective pieces of virtual camera information; and
calculate a degree of similarity between each of the plurality of pieces of virtual image information and the input image.

5. The photographing position and posture estimation apparatus according to claim 1, wherein the at least one processor is further configured to execute the instructions to generate the virtual image information for an area corresponding to a common photographing range of first virtual camera information and second virtual camera information when the 3D data is converted into an image.

6. The photographing position and posture estimation apparatus according to claim 1, wherein the at least one processor is further configured to execute the instructions to:
select, of two input images taken at different distances from an object corresponding to the 3D data, one of the images including more diverse pieces of shape information as a first input image, and selecting the other image as a second input image;
estimate a first photographing position and posture corresponding to the first input image based on a degree of similarity between the virtual image information and the first input image, and the virtual image information;
estimate a relative photographing position and posture between the first input image and the second input image; and
estimate a second photographing position and posture corresponding to the second input image based on the first photographing position and posture and the relative photographing position and posture.

7. The photographing position and posture estimation apparatus according to claim 1, wherein the at least one processor is further configured to execute the instructions to display a virtual image in which the shape feature values associated with the respective pixels of the virtual image information are converted into color information through dimensional compression.

8. A photographing position and posture estimation system comprising:
a photographing terminal; and
a photographing position and posture estimation apparatus connected to the photographing terminal so that they can communicate with each other,
wherein the at least one memory storing instructions; and
at least one processor configured to execute the instructions to:
calculate shape feature values from 3D data of a specific object;
generate virtual image information by associating the shape feature values projected onto an image area when the 3D data is converted into an image based on virtual camera information with respective pixel positions in the image area;
calculate, when the photographing terminal receives an image obtained by photographing the object as an input image, a degree of similarity between the virtual image information and the input image;
estimate a photographing position and a photographing posture corresponding to the input image based on the virtual camera information and the degree of similarity; and
return the estimated photographing position and posture to the photographing terminal.

9. A photographing position and posture estimation method comprising:
calculating shape feature values from specific 3D data;
generating virtual image information by associating the shape feature values projected onto an image area when the 3D data is converted into an image based on specific virtual camera information with respective pixel positions in the image area; and
calculating a degree of similarity between the virtual image information and an input image.
